(19) United States
(12) Patent Application Publication
(10) Pub. No.: US 2018/0025860 A1
(43) Pub. Date: Jan. 25, 2018

(54) PUSH SWITCH AND ELECTRONIC DEVICE INCLUDING PUSH SWITCH

(71) Applicants: CITIZEN ELECTRONICS CO., LTD., Yamanashi-ken (JP); CITIZEN WATCH CO., LTD., Tokyo (JP)

(72) Inventor: Ryo WAKUDA, Kofu-shi (JP)

(21) Appl. No.: 15/647,625

(22) Filed: Jul. 12, 2017

Related U.S. Application Data
(60) Provisional application No. 62/365,481, filed on Jul. 22, 2016.

(51) Int. Cl. H01H 13/14; H01H 13/50; H01H 13/02

(52) U.S. Cl. CPC H01H 13/14; H01H 13/023; H01H 13/50

(57) ABSTRACT

In a first aspect of the present disclosure, a push switch includes a resilient member that is made of metal, and the resilient member including a concave shape and an opening that is positioned at a center of the concave shape and at least two protrusions each protruding outward and downward with an oblique angle around the concave shape.

### CROSS-REFERENCE TO RELATED APPLICATION

This application is a new U.S. patent application that claims benefit of U.S. provisional application No. 62/365,481 filed on Jul. 22, 2016, the disclosures of which are incorporated herein by reference in its entirety.

### BACKGROUND OF THE INVENTION

### Field of the Invention

The subject matter herein generally relates to a push switch, and relates to an electronic device including the push switch.

Various electronic devices include push switches, and various electronic devices may include computers, portable communication devices, wearable devices, and game consoles, for example.

### Description of the Related Art

It is open to the public that a conventional push switch includes a housing, a stem arranged in the housing, a switching portion including a movable contact that is positioned under the stem to switch on or off through the stem, metal plates partly embedded in the housing, and LEDs (light-emitting diodes) arranged on either side of the stem in the housing and electrically connected to the metal plates that are partly embedded in the housing (For reference, see Japanese Unexamined Patent Application Publication No. H4-129117).

Also, it is open to the public that a lighted switch including a substrate, a switch arranged on a first surface of the substrate, a light source arranged on a second surface of the substrate, a key top to press the switch, and a light guide mechanism including a first light guiding member to hold the key top and a second light guiding member arranged to surround the light source to guide light emitted from the light source, guided through the second light guiding member to the first light guiding member holding the key top (For reference, see US Unexamined Patent Application Publication No. 2006/0065514).

Furthermore, it is open to the public that a lighted switch includes a switch substrate, an LED mounted on the switch substrate, a contact fixed on the switch substrate, a spring plate arranged over the contact fixed on the switch substrate and including an opening in which the LED is arranged in a plan view (For reference, Japanese Unexamined Patent Application Publication No. 2008-27642).

### SUMMARY OF THE INVENTION

In a first aspect of the present inventive subject matter, a push switch includes a resilient member made of metal and includes a concave shape, an opening that is positioned at a center of the concave shape, and at least two protrusions each protruding outward and downward with an oblique angle around the concave shape.

In a second aspect of the present inventive subject matter, a push switch includes a resilient member including a concave shape, a flat portion that is extended outward from an outer edge of the concave shape, and four protrusions. The four protrusions each protrude outward and downward with an oblique angle from an outer edge of the flat portion.

In a third aspect of the present inventive subject matter, a push switch includes an electrically-insulating member; upper electrodes arranged on an upper surface of the electrically-insulating member and including a first electrode and a second electrode that is positioned outside of the first electrode; a resilient member including a concave shape and an opening that is positioned at a center of the concave shape. The resilient member includes an annular portion that defines the opening and is in contact with the first electrode of the upper electrodes. The push switch further includes a light-emitting element arranged in the opening that is positioned at the center of the concave shape of the resilient member. The resilient member further includes a flat portion that is extended outward from an outer edge of the concave shape and a protrusion protruding outward and downward with an oblique angle from an outer edge of the flat portion. The protrusion of the resilient member includes an end that is arranged above the second electrode.

### BRIEF DESCRIPTION OF THE DRAWING

FIG. 1A shows a top perspective view of a push switch according to a first embodiment of the subject matter.

FIG. 1B shows a cross-sectional view of a push switch, taken along a dotted line IB-IB shown in FIG. 1A.

FIG. 1C shows an explosive perspective view of a push switch according to a first embodiment of the subject matter.

FIG. 1D shows a bottom perspective view of a push switch according to an embodiment of the subject matter, showing an example of arrangement of lower electrodes arranged on a lower surface of an electrically-insulating member.

FIG. 1E shows a top perspective view of an electrically-insulating member including upper electrodes on which a light-emitting element is electrically mounted.

FIG. 1F shows a top perspective view of an electrically-insulating member including upper electrodes, on which a light-emitting element is electrically mounted, and further including upper electrodes, on which a resilient member is electrically mounted.

FIG. 1G shows a top perspective view of a frame including an opening in which the light-emitting element and the resilient member electrically mounted on the electrically-insulating member shown in FIG. 1F are arranged.

FIG. 2A shows a top perspective view of a push switch according to a second embodiment of the subject matter.

FIG. 2B shows a cross-sectional view of a push switch, taken along a dotted line IIB-IIB shown in FIG. 2A.

FIG. 2C shows an explosive perspective view of a push switch according to a second embodiment of the subject matter.

FIG. 2D shows a bottom perspective view of a push switch according to an embodiment of the subject matter, showing an example of arrangement of lower electrodes, arranged on a lower surface of an electrically-insulating member.

FIG. 2E shows a top perspective view of an electrically-insulating member including upper electrodes on which a light-emitting element is electrically mounted.

FIG. 2F shows a top perspective view of an electrically-insulating member including upper electrodes on which a light-emitting element and a resilient member are electrically mounted.

FIG. 2G shows a top perspective view of a frame including an opening in which the light-emitting element and the resilient member electrically mounted on the electrically-insulating member shown in FIG. 2F are arranged. The frame is arranged on the electrically insulating member.

FIG. 3A shows a motherboard of an electronic device and a push switch, according to an embodiment of the subject matter. The push switch is electrically connected to the motherboard.

FIG. 3B shows a cross-sectional view of a push switch that is electrically connected to a motherboard of an electronic device, taken along a dotted line IIB-IIB shown in FIG. 2A.

FIG. 4 shows a top perspective view of a frame including an opening, in which the resilient member electrically mounted on the electrically-insulating member as shown in FIG. 1F is arranged. The frame is arranged on the electrically insulating member. In this embodiment, a light-emitting element may not be arranged.

### DETAILED DESCRIPTION OF EMBODIMENTS

As used herein, the term “and/or” includes any and all combinations of one or more of the associated listed items.

The terminology used herein is for the purpose of describing particular embodiments only and is not intended to be limiting of the subject matter. As used herein, the singular forms “a”, “an” and “the” are intended to include the plural forms as well, unless the context clearly indicates otherwise.

As illustrated in the figures submitted herewith, some sizes of structures or portions may be exaggerated relative to other structures or portions for illustrative purposes.

Relative terms such as “below” or “above” or “upper” or “lower” or “top” or “bottom” may be used herein to describe a relationship of one element, layer or region to another element, layer or region as illustrated in the figures. It will be understood that these terms are intended to encompass different orientations of a device in addition to the orientation depicted in the figures.

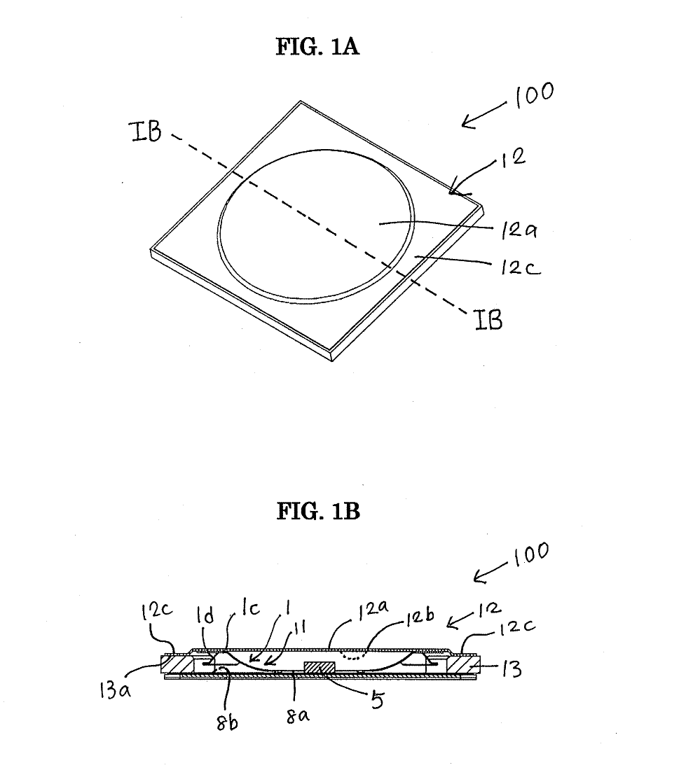

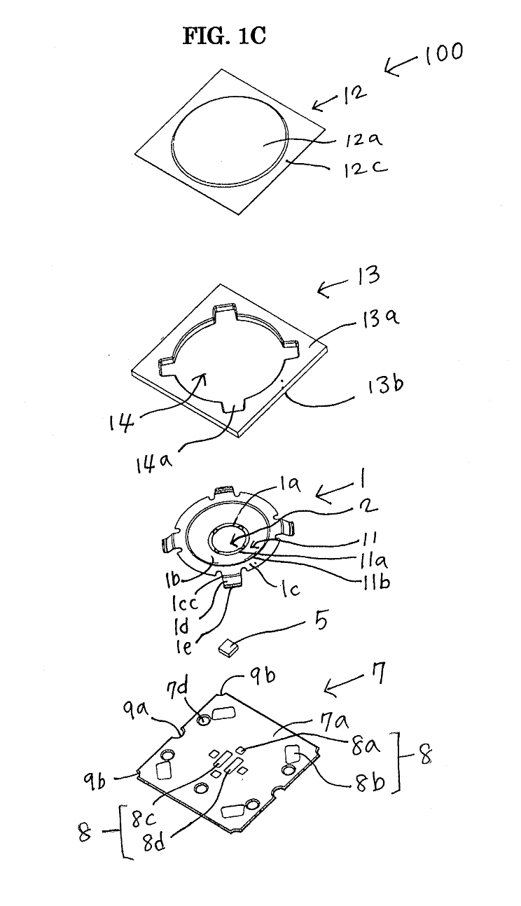

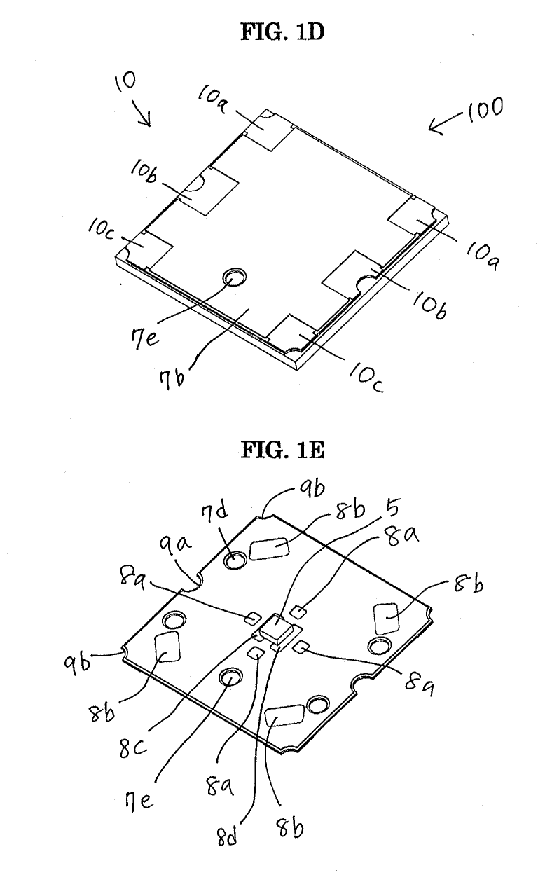

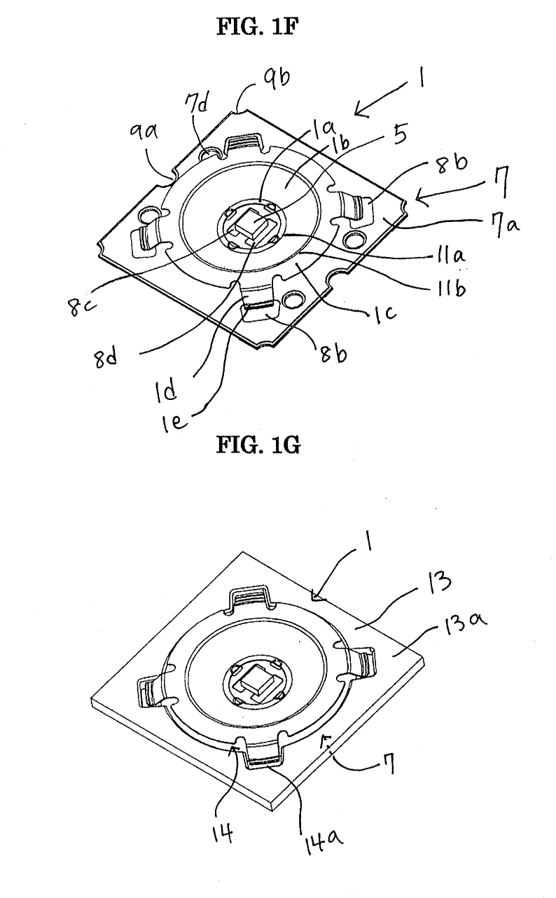

FIG. 1A shows a top perspective view of a push switch according to a first embodiment of the subject matter.

FIG. 1B shows a cross-sectional view of a push switch, taken along a dotted line IB-IB shown in FIG. 1A.

A push switch 100 includes a resilient member 1 made of metal. The resilient member 1 includes a concave shape 11 and an opening 2 that is positioned at a center of the concave shape 11. The resilient member 1 further includes at least two protrusions each protruding outward and downward with an oblique angle around the concave shape.

The push switch 100 may further include a light-emitting element 5 arranged in the opening 2 that is positioned at the center of the concave shape 11 of the resilient member 1. The opening 2 is positioned at the bottom of the concave shape 11. The concave shape 11 of the resilient member 1 surrounding the light-emitting element 5 may include a curved surface.

The light-emitting element 5 may be a light-emitting diode (LED). The light-emitting element 5 may include a phosphor layer. Also, the light-emitting element 5 may be sealed by a light-transmitting resin. The light-transmitting resin may be transparent or translucent to transmit light. The light-transmitting resin may include a phosphor.

When the light-emitting element 5 is activated to emit light by application of voltage to the light-emitting element 5, the concave shape 11 of the resilient member 1 is configured to reflect light from the light-emitting element 5 upward. The resilient member 1 made of metal. The resilient member 1 may be made of stainless steel.

The push switch 100 may include a film 12 arranged over the resilient member 1 with the opening 2 in which the light-emitting element 5 is arranged. The film 12 may be a light-transmitting film made of resin.

Light emitted from the light-emitting element 5 and reflected light on a curved surface 1b in the concave shape 11 of the resilient member 1 are configured to transmit the film 12 that may be transparent or translucent.

The film 12 may be made of polyimide resin, for example. Also, the film 12 may be made of fluorine resin. The resilient member 1 may be partly in contact with a lower surface 12b of the film 12.

The film 12 may be adhered to an upper surface 13a of the frame 13 at a peripheral portion 12c of the film 12. The frame 13 may include a projecting portion (not shown) at a lower surface 13b of the frame 12 to position the frame 13 on an upper surface 7a of the substrate 7.

Also, the electrically-insulating member 7 may include a recessed portion 7d to receive the projecting portion of the frame 13. Also, the electrically-insulating member 7 may include an air hole 7e that may pass through the electrically-insulating member 7.

Whether providing a projecting portion at the lower surface 13b of the frame 13 or not can be freely chosen. The number, shape and arrangement of projecting portion to position the frame 13 are freely chosen according to the shape, size and arrangement of the electrically-insulating member 7, for example.

A push switch according to the subject matter may be used in various electronic devices. Such an electronic device includes a push switch including a light-emitting element. The electronic device may be a computer, portable communication device, wearable device, and game console, on-vehicle device for example. An electronic device may require a push switch that is configured to emit light.

FIG. 1C shows an explosive perspective view of a push switch according to a first embodiment of the subject matter.

For more details, a push switch 100 includes a resilient member 1. The resilient member 1 includes a concave shape 11 and an opening 2 that is positioned at a center of the concave shape 11, a flat portion 1c that is extended outward from an outer edge 11b of the concave shape 11, and a protrusion 1d protruding outward and downward with an oblique angle from an outer edge 1cc of the flat portion 1c.

The push switch 100 may further include a light-emitting element 5 arranged in the opening 2 that is positioned at a center of the concave shape 11 of the resilient member 1.

When the push switch 100 is pressed down from above an upper surface 12a of the film 12, the flat portion 1c of the resilient member 1 is pressed down through the film 12.

Accordingly, the end 1e the protrusion 1d that protrudes outward and downward with an oblique angle from an outer edge 1cc of the flat portion 1c becomes in contact with the second electrode 8b arranged on an upper surface 7a of the electrically-insulating member 7, and the first electrode 8a and the second electrode 8b are electrically connected by the resilient member 1.

The at least two protrusions may be four protrusions as shown in FIG. 1F and FIG. 1G, for example. The four protrusions 1d each protrude outward and downward with an oblique angle from the outer edge 1cc of the flat portion 1c. The four protrusions 1d may be arranged at the outer edge 1cc of the flat portion 1c with an equal distance to an adjacent protrusion of the four protrusions. Accordingly, four electrical contacts may be obtained by the resilient member 1 in four directions.

FIG. 1D shows a bottom perspective view of a push switch according to an embodiment of the subject matter, showing an example of arrangement of lower electrodes 10 (10a, 10b, and/or 10c) of an electrically-insulating member 7.

FIG. 1E shows a top perspective view of an electrically-insulating member including electrodes on which a light-emitting element is electrically mounted. The electrically-insulating member may be used in a push switch according to an embodiment of the subject matter.

For more details, a push switch 100 includes an electrically-insulating member 7. The push switch 100 further includes upper electrodes 8 arranged on an upper surface 7a of the electrically-insulating member 7. The upper electrodes 8 include a first electrode 8a and a second electrode 8b that is positioned outside of the first electrode 8a.

The first electrode 8a may be arranged to be around a third electrode 8c and a fourth electrode 8d to which a light-emitting element 5 may be electrically mounted.

Also, the second electrode 8b may be arranged to be around the first electrode 8a.

The push switch 100 further includes the resilient member 1. The resilient member 1 further includes an annular portion 1a that defines the opening 2. The annular portion 1a is positioned adjacent to an inner edge 11a of the concave shape 11. The annular portion 1a is arranged to be in contact with the first electrode 8a of the electrodes 8. The annular portion 1a may include a flat surface to be in contact with the first electrode 8a. The push switch 100 further includes a light-emitting element 5 arranged in the opening 2 that is positioned at the center of the concave shape 11 of the resilient member 1. The concave shape 11 of the resilient member 1 surrounds the light-emitting element 5.

The resilient member 1 may include a curved surface 1b at the concave shape 11. The curved surface 1b of the concave shape 11 may be a polished surface to reflect light from the light-emitting element 5. The resilient member 1 further includes a flat portion 1c that protrudes outward from an outer edge 11b of the concave shape 11 and a protrusion 1d protruding outward and downward with an oblique angle from an outer edge 1cc of the flat portion 1c. The protrusion 1d of the resilient member 1 includes an end 1e that is arranged above the second electrode 8b.

When the push switch 100 is pressed down from above an upper surface 12a of the film 12, the flat portion 1c of the resilient member 1 is pressed down through the film 12.

Accordingly, the end 1e the protrusion 1d that protrudes outward and downward with an oblique angle from an outer edge 1cc of the flat portion 1c becomes in contact with the second electrode 8b arranged on an upper surface 7a of the electrically-insulating member 7, and the first electrode 8a and the second electrode 8b are electrically connected by the resilient member 1.

In this embodiment, it is possible to arrange a light-emitting element 5 at a center of a push switch; and the curved surface 1b of the concave shape 11 of the resilient member 1 is configured to reflect light from the light-emitting element 5 upward.

For more details, the light-emitting element 5 is positioned in the opening 2a of the resilient member 1, and the opening 2a of the resilient member 1 is positioned at a bottom of the concave shape 2. The light-emitting element 5 may be electrically mounted on the third electrode 8c and the fourth electrode 8d. The opening 2a of the resilient member 1 may have a diameter in a range of 0.5 mm to 5 mm. The size of the opening 2a of the resilient member 1 may vary depending on a size of push switch.

FIG. 1F shows a top perspective view of an electrically-insulating member 7 including upper electrodes 8c, 8d, on which alight-emitting element 5 is electrically mounted, and further including upper electrodes 8a, on which a resilient member 1 is electrically mounted. The electrically-insulating member 7 may be a substrate made of resin, for example. The substrate may be used as an electrically-insulating member in a push switch, according to an embodiment of the subject matter.

FIG. 1G shows a top perspective view of a frame 13 including an opening 14 in which the light-emitting element 5 and the resilient member 1 electrically mounted on the electrically-insulating member shown in FIG. 1F are arranged. The frame 13 including the opening 14 is arranged on the electrically insulating member 7.

The push switch 100 may include the frame 13. A light-emitting element and a resilient member might be electrically mounted on upper electrodes 8 arranged on an upper surface 7a of the electrically-insulating member 7 in the opening 14 of the frame 13. The electrically-insulating member 7 and the frame 13 may be provided as separate elements. The frame 13 may be adhered to an upper surface 7a of the electrically-insulating member 7. The light-emitting element 5 and the resilient member 1 may be positioned in the opening 14 of the frame 13. The opening 14 may have a shape in which the resilient member 1 fits. The opening 14 of the frame 13 may include a notch 14a as a part of the opening 14. The protrusion 1d of the resilient member 1 may be fit in the notch 14a. The flat portion 1c of the resilient member 1 may be positioned higher than the upper surface 13a of the frame 13, as shown in FIG. 1B.

Also, the electrically-insulating member 7 and the frame 13 may be provided as an integral resin body including a recess in which a light-emitting element 5 and a resilient member 1 are arranged.

The light-emitting element 5 and the resilient member 1 may be electrically mounted on the electrically-insulating member 7 in the opening 14 of the frame 13. The electrically-insulating member 7 and the frame 13 may be provided as separate elements. Also, the electrically-insulating member 7 and the frame 13 may be provided as a resin body including a recess in which a light-emitting element 5 and a resilient member 1 are arranged.

A light-emitting element 5 and a resilient member 1 are electrically mounted on the electrically-insulating member 7 in the opening of the frame 13. The electrically-insulating member 7 and the frame may be provided as separate elements. Also, the electrically-insulating member 7 and the frame may be provided as a resin body including a recess in which upper electrodes 8 are arranged and a light-emitting element 5 and a resilient member 1 are electrically connected to the upper electrodes 8.

When the light-emitting element 5 is activated to emit light by application of voltage to the light-emitting element 5 through upper electrodes 8, the concave shape 11 of the resilient member 1 is configured to reflect light from the light-emitting element 5 upward.

The resilient member 1 may be made of metal. The resilient member 1 may be made of stainless steel.

Furthermore, when the push switch 100 is pressed down from above, the flat portion 1c of the resilient member 1 is pressed down from above.

Accordingly, the end 1e the protrusion 1d that protrudes outward and downward with an oblique angle from an outer edge 1cc of the flat portion 1c becomes in contact with the second electrode 8b arranged on an upper surface 7a of the electrically-insulating member 7, and the first electrode 8a and the second electrode 8b are electrically connected by the resilient member 1.

The electrically-insulating member 7 may be a substrate including a resin. The substrate may include a through-hole that passes through the substrate from an upper surface to a lower surface of the substrate. Also, an electrode arranged on an upper surface 7a of the electrically-insulating member 7 may be electrically connected to the through-hole. Furthermore, it is possible to arrange an electrode pattern on the upper surface 7a of the electrically-insulating member 7, a through-hole that may be a ½ through-hole 9a at a side 7c of the substrate and/or a through-hole that may be a ¼ through-hole 9b at a corner of the electrically-insulating member 7.

The number, shape and arrangement of electrodes, wiring pattern, and/or through-holes are freely chosen for electrical connections to the resilient member 1 and/or the light-emitting element 5, for example.

Also, the electrically-insulating member 7 may be a resin body including metal leads, which may be electrically connected to the resilient member 1. Also, the metal leads may be electrically connected to the light-emitting element 5.

Furthermore, the electrically-insulating member 7 may include a casing in which the resilient member 1 may be arranged.

Accordingly, metal leads and/or a lead frame may be arranged in and/or on the electrically-insulating member 7 in combination with electrodes or instead of electrodes and/or through-holes.

For more details, the upper electrodes 8 further includes a third electrode 8c and a fourth electrode 8d to that the light-emitting element 5 is electrically connected.

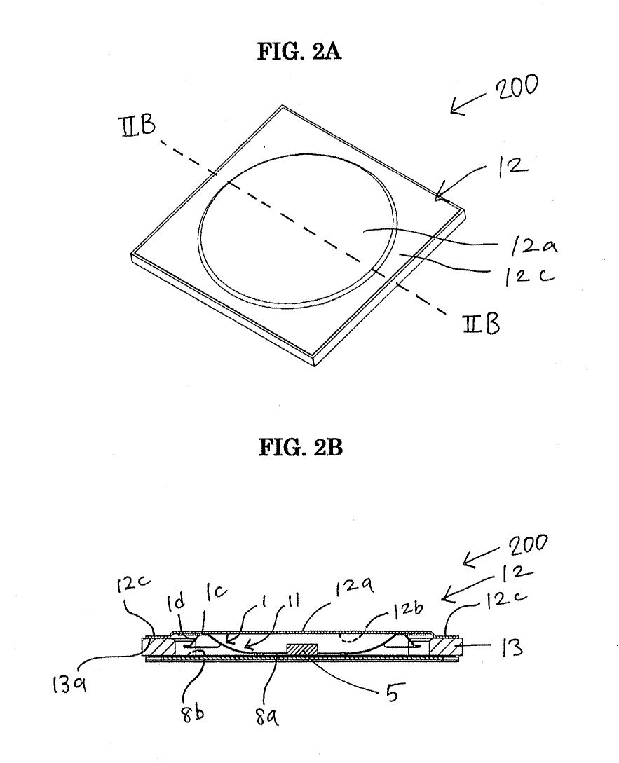

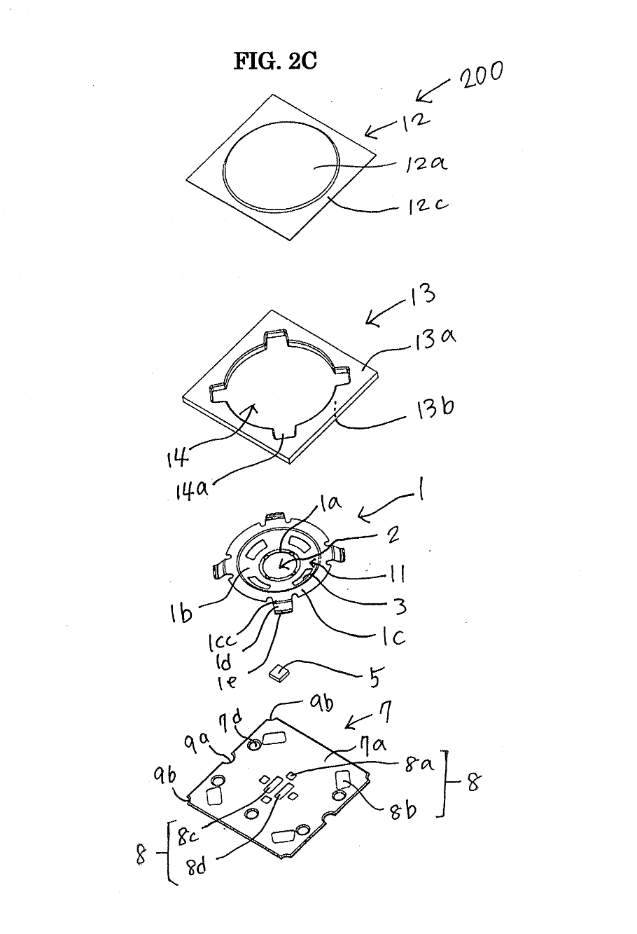

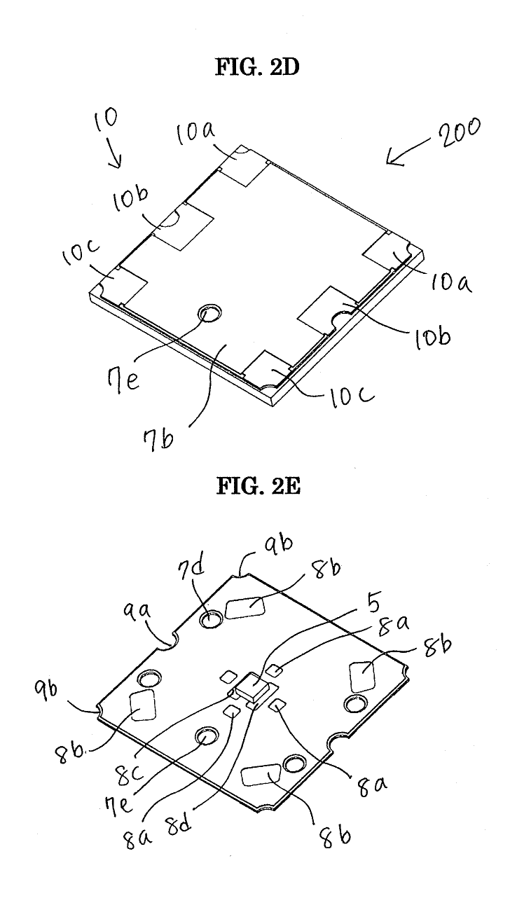

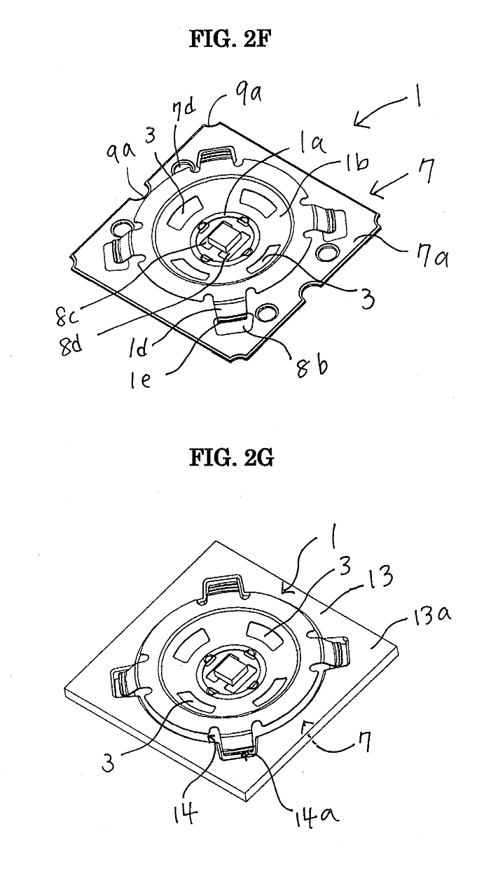

FIG. 2A shows a top perspective view of a push switch according to a second embodiment of the subject matter.

FIG. 2B shows a cross-sectional view of a push switch taken along a dotted line IIB-IIB shown in FIG. 2A.

A push switch 200 includes a resilient member 1 made of metal. The resilient member 1 includes a concave shape 11 and an opening 2 that is positioned at a center of the concave shape 11. The push switch 200 further includes a light-emitting element 5 arranged in the opening 2 that is positioned at the center of the concave shape 11 of the resilient member 1. The opening 2 is positioned at the bottom of the concave shape 11.

The push switch 200 may include a film 12 arranged over the resilient member 1 with the opening 2 in which the light-emitting element 5 is arranged. The film 12 is a light-transmitting film made of resin.

Light emitted from the light-emitting element 5 and reflected light on the curved surface 1b in the concave shape 11 of the resilient member 1 are configured to transmit the film 12 that may be transparent or translucent.

The opening 2 of the resilient member 1 is positioned at a bottom of the concave shape 11 of the resilient member 1.

The opening 2 of the resilient member 1 may have a diameter in a range of 0.5 mm to 5 mm. The size of the opening 2a of the resilient member 1 may vary depending on a size of push switch.

FIG. 2C shows an explosive perspective view of a push switch according to a second embodiment of the subject matter.

For more details, a push switch 200 includes a resilient member 1. The resilient member 1 includes a concave shape 11 and an opening 2 that is positioned at a center of the concave shape 11, a flat portion 1c that is extended outward from an outer edge 11b of the concave shape 11, and a protrusion 1d protruding outward and downward with an oblique angle from an outer edge 1cc of the flat portion 1c.

The push switch 200 further includes a light-emitting element 5 arranged in the opening 2 that is positioned at a center of the concave shape 11 of the resilient member 1.

FIG. 2D shows a bottom perspective view of a push switch according to an embodiment of the subject matter, showing an example of arrangement of lower electrodes 10 arranged on a lower surface 7b of an electrically-insulating member 7. The lower electrodes 10 (10a, 10b, and/or 10c) of the electrically-insulating member 7 may be electrically connected to electrodes of a motherboard of an electronic device.

The number, shape and arrangement of electrodes, wiring pattern, and/or through-holes are freely chosen for electrical connections to the resilient member 1 and/or the light-emitting element 5, for example.

FIG. 2E shows a top perspective view of an electrically-insulating member including upper electrodes on which a light-emitting element is electrically mounted. The electrically-insulating member may be used in a push switch according to an embodiment of the subject matter.

FIG. 2F shows a top perspective view of an electrically-insulating member including upper electrodes on which a light-emitting element and a resilient member are electrically mounted. The electrically-insulating member may be a substrate. The substrate may be used in a push switch according to an embodiment of the subject matter.

For more details, a push switch 200 includes an electrically-insulating member 7. The push switch 200 further includes upper electrodes 8 arranged on an upper surface 7a of the electrically-insulating member 7. The upper electrodes 8 include a first electrode 8a and a second electrode 8b that is positioned outside of the first electrode 8a.

The first electrode 8a may be arranged to be around a third electrode 8c and a fourth electrode 8d to which a light-emitting element 5 may be electrically mounted. The first electrode 8a may include one or more upper electrodes.

Also, the second electrode 8b may be arranged to be around the first electrode 8a. The second electrode 8b may include one or more upper electrodes.

The push switch 200 further includes the resilient member 1. The resilient member 1 further includes an annular portion 1a that defines the opening 2. The annular portion 1a is arranged to be in contact with the first electrode 8a of the electrodes 8. The annular portion 1a may include a flat surface to be in contact with the first electrode 8a. The push switch 200 further includes a light-emitting element 5 arranged in the opening 2 that is positioned at the center of the concave shape 11 of the resilient member 1. The concave shape 11 of the resilient member 1 surrounds the light-emitting element 5.

The resilient member 1 may include a curved surface 1b at the concave shape 11. The curved surface 1b of the concave shape 11 may be a polished surface to reflect light from the light-emitting element 5. The resilient member 1 further includes a flat portion 1c that is extended outward from an outer edge 11b of the concave shape 11 and a protrusion 1d protruding outward and downward with an oblique angle from an outer edge 1cc of the flat portion 1c. The protrusion 1d of the resilient member 1 includes an end 1e that is arranged above the second electrode 8b.

In this embodiment, it is possible to arrange a light-emitting element at a center of a push switch and the concave shape of the resilient member 1.

The curved surface 1b of the concave shape 11 of the resilient member 1 may further include one or more openings 3. The one or more openings 3 may guide light sideways of the resilient member 1.

Also, the one or more openings 3 passing through the curved surface 1b of the concave shape 11 of the resilient member 1 are configured to pass light from the light-emitting element 5 through the one or more openings 3 sideways.

Accordingly, the push switch 200 according to this embodiment may emit light with a wider angle, sideways as well as upward, compared to the push switch 100 according to the first embodiment.

The push switch 200 may include a film 12. The film 12 is a light-transmitting film. Also, the push switch 200 may further include a frame 13. The frame 13 may be made of light-transmitting resin to transmit light emitted from the light-emitting element 5. The electrically-insulating member 7 may be made of white-colored resin to reflect light.

A light-emitting element 5 and a resilient member 1 may be electrically mounted on the third electrode 8c and the fourth electrode 8d of the upper electrodes 8 arranged on an upper surface 7a of the electrically-insulating member 7 in the opening 14 of the frame 13.

The electrically-insulating member 7 and the frame 13 may be provided as separate elements. The frame 13 may be adhered to an upper surface 7a of the electrically-insulating member 7. The frame 13 may include an opening 14 having a shape in which the resilient member 1 fits. The light-emitting element 5 and the resilient member 1 may be positioned in the opening 14 of the frame 13.

FIG. 2G shows a top perspective view of an electrically-insulating member on which a frame 13 including an opening is arranged. A light-emitting element 5 and a resilient member 1 may be electrically mounted on the electrically-insulating member 7 in the opening 14 of the frame 13.

The electrically-insulating member 7 and the frame 13 may be provided as separate elements. The frame may be adhered on an upper surface of the electrically-insulating member 7. Also, the electrically-insulating member 7 and the frame 13 may be provided as a resin body including a recess in which a light-emitting element 5 and a resilient member 1 are arranged.

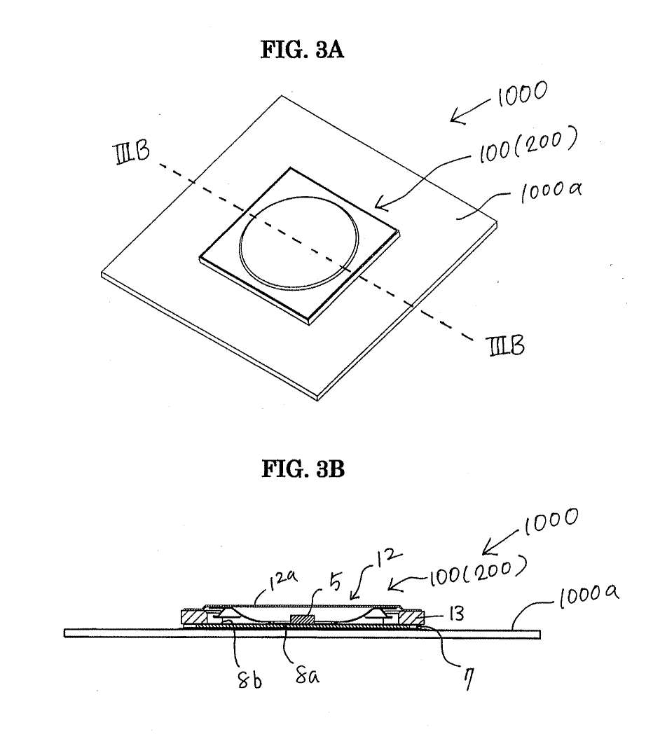

FIG. 3A shows a motherboard 1000 of an electronic device, and a push switch 100 and/or 200 is electrically connected to the motherboard 1000.

FIG. 3B shows a cross-sectional view of a push switch on the motherboard 1000, taken along a dotted line IIB-IIB shown in FIG. 3A.

The lower electrodes 10 (10a, 10b, and/or 10c) of the electrically-insulating member 7 may be electrically connected to electrodes of a motherboard of an electronic device. The lower electrodes 10 (10a, 10b, and/or 10c) of the push switch may be soldered on electrodes arranged on an upper surface 1000a of the motherboard 1000.

An electronic device includes a motherboard 1000 and a push switch according to the subject matter disclosed herein. The motherboard 1000 includes electrodes that may include a first electrode and a second electrode to which the push switch 100 and/or 200 is electrically connected.

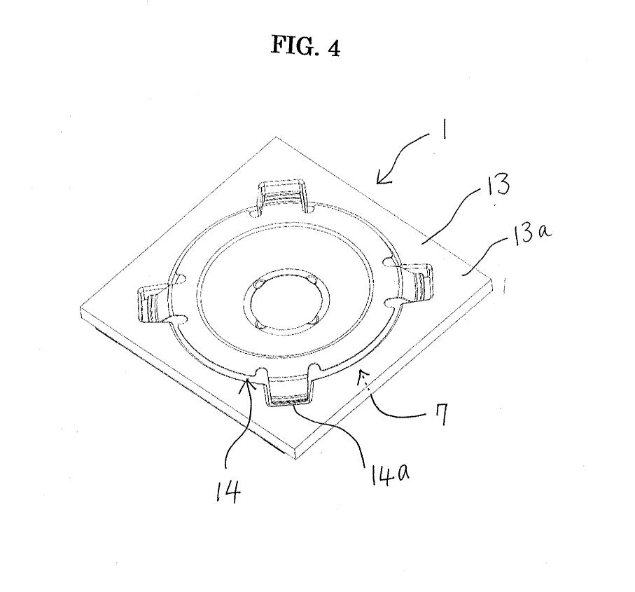

FIG. 4 shows a top perspective view of a frame including an opening, in which the resilient member electrically mounted on the electrically-insulating member as shown in FIG. 1F is arranged. The frame is arranged on the electrically insulating member. In this embodiment, a light-emitting element may not be arranged in a center of the resilient member 1.

In this embodiment, the resilient member 1 includes four protrusions 1d each protruding outward and downward with an oblique angle from the outer edge 1cc of the flat portion 1c. The four protrusions 1d may be arranged at the outer edge 1cc of the flat portion 1c with an equal distance to an adjacent protrusion of the four protrusions. Accordingly, four electrical contacts may be obtained by the resilient member 1 in four directions, and a four-way key may be arranged over the resilient member 1.

Various electronic devices include push switches. An electronic device includes the push switch according to an embodiment of the subject matter, and a motherboard includes a first electrode and a second electrode. The push switch may be electrically connected to the first electrode and the second electrode of the motherboard of the electronic device.

Furthermore, while certain embodiments of the present inventive subject matter have been illustrated with reference to specific combinations of elements, various other combinations may also be provided without departing from the teachings of the present inventive subject matter. Thus, the present inventive subject matter should not be construed as being limited to the particular exemplary embodiments described herein and illustrated in the Figures, but may also encompass combinations of elements of the various illustrated embodiments.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

What is claimed is:

1. A push switch comprising:
a resilient member made of metal and comprising a concave shape, an opening that is positioned at a center of the concave shape, and at least two protrusions each protruding outward and downward with an oblique angle around the concave shape.

2. The push switch according to claim 1 further comprising:
an electrically insulating member, wherein
the electrically insulating member comprises an electrode on which the concave shape of the resilient member made of metal is arranged.

3. The push switch according to claim 1 further comprising:
an electrically insulating member, wherein
the electrically insulating member comprising metal leads to which the resilient member made of metal is electrically connected.

4. The push switch according to claim 1 further comprising:
a light-emitting element arranged in the opening that is positioned at the center of the concave shape of the resilient member, wherein
the concave shape surrounding the light-emitting element comprises a curved surface.

5. The push switch according to claim 4, wherein
the curved surface of the concave shape surrounding the light-emitting element comprises one or more openings.

6. The push switch according to claim 1,
wherein the opening that is positioned at the center of the concave shape of the resilient member is positioned at a bottom of the concave shape.

7. The push switch according to claim 6,
wherein the opening that is positioned at the center of the concave shape of the resilient member 1 has a diameter in a range of 0.5 mm to 5 mm.

8. A push switch comprising:
a resilient member comprising a concave shape, a flat portion that is extended outward from an outer edge of the concave shape, and four protrusions each protruding outward and downward with an oblique angle from an outer edge of the flat portion.

9. The push switch according to claim 8, further comprising:
an opening that is positioned at a center of the concave shape; and
a light-emitting element arranged in the opening that is positioned at the center of the concave shape of the resilient member,
wherein the concave shape surrounding the light-emitting element comprises a curved surface.

10. The push switch according to claim 9, wherein
the curved surface of the concave shape surrounding the light-emitting element comprises one or more openings.

11. The push switch according to claim 8,
wherein the opening that is positioned at the center of the concave shape of the resilient member is positioned at a bottom of the concave shape.

12. The push switch according to claim 11, wherein
the opening that is positioned at the center of the concave shape of the resilient member has a diameter in a range of 0.5 mm to 5 mm.

13. A push switch comprising:
an electrically-insulating member;
upper electrodes arranged on an upper surface of the electrically-insulating member and comprising a first electrode and a second electrode that is positioned outside of the first electrode;
a resilient member comprising a concave shape and an opening that is positioned at a center of the concave shape, the resilient member comprising an annular portion that defines the opening and that is in contact with the first electrode of the upper electrodes;
a light-emitting element arranged in the opening that is positioned at the center of the concave shape of the resilient member,
the resilient member further comprises a flat portion that is extended outward from an outer edge of the concave shape and a protrusion protruding outward and downward with an oblique angle from an outer edge of the flat portion,
the protrusion of the resilient member comprises an end that is arranged above the second electrode.

14. The push switch according to claim 13 further comprising:
a film arranged over the resilient member.

15. The push switch according to claim 14, wherein
the film is a light-transmitting film.

16. The push switch according to claim 13, wherein
the upper electrodes further comprising a third electrode and a fourth electrode to that the light-emitting element is electrically connected.

17. The push switch according to claim 13, wherein
the concave shape surrounding the light-emitting element comprises a curved surface, and
the curved surface of the concave shape surrounding the light-emitting element comprises one or more openings.

18. The push switch according to claim 13,
wherein the opening that is positioned at the center of the concave shape of the resilient member is positioned at a bottom of the concave shape.

19. The push switch according to claim 13,
wherein the opening that is positioned at the center of the concave shape of the resilient member has a diameter in a range of 0.5 mm to 5 mm.

20. An electronic device comprising:
the push switch of claim 1; and
a motherboard comprising a first electrode and a second electrode, wherein the push switch is electrically connected to the first electrode and the second electrode of the motherboard.
